(19) United States
(12) Patent Application Publication
(10) Pub. No.: US 2025/0358877 A1
(43) Pub. Date: Nov. 20, 2025

(54) IDENTIFICATION AND DISCOVERY OF DEVICE

(71) Applicant: Nokia Technologies Oy, Espoo (FI)

(72) Inventors: Jianguo LIU, Shanghai (CN); Zhijie YANG, Shanghai (CN); Yan MENG, Shanghai (CN); Tao TAO, Shanghai (CN); Wenjian WANG, Shanghai (CN); Mika KASSLIN, Espoo (FI)

(21) Appl. No.: 18/862,745

(22) PCT Filed: May 6, 2022
(86) PCT No.: PCT/CN2022/091269

§ 371 Date: Nov. 4, 2024

(51) Int. Cl. H04W 76/15; H04W 48/16

(52) U.S. Cl. CPC H04W 76/15; H04W 48/16

(57) ABSTRACT

Embodiments of the present disclosure relate to apparatuses, methods, devices and computer readable storage media for identification and discovery of a device. The apparatus transmits, to a first AP in a second apparatus, an MLD MAC address of a non-AP MLD. In response to a second AP MLD in the second apparatus being created based on an association between the MLD MAC address of the non-AP MLD and a private SSID of the second AP MLD, the apparatus receives the private SSID from the second AP MLD. In turn, the apparatus establishes a connection between the apparatus and the second AP MLD using at least the private SSID.

### FIELD

Embodiments of the present disclosure generally relate to the field of telecommunication and, in particular, to apparatuses, methods, devices and computer readable storage media for identification and discovery of a device.

### BACKGROUND

Multi-link operation (MLO) has been identified as an important feature of institute of electrical and electronics engineers (IEEE) 802.11be. MLO targets efficient operations in all the available bands, such as 2.4 GHz, 5 GHZ, and 6 GHz, for load balancing, multi-band aggregation, and simultaneous downlink and uplink transmission.

In 802.11be, a multi-link device (MLD) is a logical entity. The MLD may have more than one affiliated station (STA) and have a single medium access control (MAC) to logical link control (LLC) with a single MAC data service. An MLD MAC address may be used to identify the MLD entity. an MAC address of access points (AP) affiliated with an AP MLD may be different from each other. If each AP affiliated with an AP MLD has a different MAC address, then when a non-AP MLD is associated with the AP MLD, each non-AP STA affiliated with the non-AP MLD has a different MAC address. In 802.11be, MLO enables a non-AP MLD to discover, authenticate, associate, and set up multiple links with an AP MLD.

### SUMMARY

Example embodiments of the present disclosure provide an improved solution for identification and discovery of a device.

In a first aspect, there is provided an apparatus. The apparatus comprises at least one processor and at least one memory storing instructions. The instructions, when executed by the at least one processor, cause the apparatus at least to: transmit, to a first AP in a second apparatus, an MLD MAC address of a non-AP MLD; in response to a second AP MLD in the second apparatus being created based on an association between the MLD MAC address of the non-AP MLD and a private SSID of the second AP MLD, receive the private SSID from the second AP MLD; and establish a connection between the apparatus and the second AP MLD using at least the private SSID.

In a second aspect, there is provided an apparatus. The apparatus comprises at least one processor and at least one memory storing instructions. The instructions, when executed by the at least one processor, cause the apparatus at least to: receive, at a first AP in the apparatus from a first apparatus, an MLD MAC address of a non-AP MLD, the first apparatus being affiliated with the non-AP MLD; in accordance with a determination that the MLD MAC address of the non-AP MLD is associated with a private SSID of a second AP MLD, create the second AP MLD; and transmit the private SSID to the first apparatus for establishment of a connection between the first apparatus and the second AP MLD.

In a third aspect, there is provided a method. The method comprises: transmitting, from an apparatus to a first AP in a second apparatus, an MLD MAC address of a non-AP MLD, the apparatus being affiliated with the non-AP MLD; in response to a second AP MLD in the second apparatus being created based on an association between the MLD MAC address of the non-AP MLD and a private SSID of the second AP MLD, receiving the private SSID from the second AP MLD; and establishing a connection between the apparatus and the second AP MLD using at least the private SSID.

In a fourth aspect, there is provided a method. The method comprises: receiving, at a first AP in an apparatus from a first apparatus, an MLD MAC address of a non-AP MLD, the first apparatus being affiliated with the non-AP MLD; in accordance with a determination that the MLD MAC address of the non-AP MLD is associated with a private SSID of a second AP MLD, creating the second AP MLD; and transmitting the private SSID to the first apparatus for establishment of a connection between the first apparatus and the second AP MLD.

In a fifth aspect, there is provided an apparatus comprising a first device. The first device has: means for transmitting, to a first AP in a second device, an MLD MAC address of a non-AP MLD, the apparatus being affiliated with the non-AP MLD; in response to a second AP MLD in the second device being created based on an association between the MLD MAC address of the non-AP MLD and a private SSID of the second AP MLD, means for receiving the private SSID from the second AP MLD; and means for establishing a connection between the apparatus and the second AP MLD using at least the private SSID.

In a sixth aspect, there is provided an apparatus comprising a second device. The second device has: means for receiving, at a first access-point -AP- in the second device from a first device, an MLD MAC address of a non-AP MLD, the first device being affiliated with the non-AP MLD; in accordance with a determination that the MLD MAC address of the non-AP MLD is associated with a private SSID of a second AP MLD in the second device, means for creating the second AP MLD; and means for transmitting the private SSID to the first device for establishment of a connection between the first device and the second AP MLD.

In a seventh aspect, there is provided a computer readable medium. The non-transitory computer readable medium comprises program instructions for causing an apparatus to perform the method according to the third aspect.

In an eighth aspect, there is provided a computer readable medium. The non-transitory computer readable medium comprises program instructions for causing an apparatus to perform the method according to the fourth aspect.

It is to be understood that the summary section is not intended to necessarily identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example implementations will now be described with reference to the accompanying drawings, where:

FIG. 1 illustrates an example communication environment in which embodiments of the present disclosure can be implemented;

FIG. 2 illustrates another example communication environment in which embodiments of the present disclosure can be implemented;

FIG. 3 illustrates a signaling chart illustrating a process for identification and discovery of a device in accordance with some example implementations of the present disclosure;

FIG. 4 illustrates a signaling chart illustrating a process for identification and discovery of a device in accordance with some example implementations of the present disclosure;

FIG. 5 shows a flowchart of an example method in accordance with some example implementations of the present disclosure;

FIG. 6 shows a flowchart of an example method in accordance with some example implementations of the present disclosure;

FIG. 7 illustrates a simplified block diagram of an apparatus that is suitable for implementing example implementations of the present disclosure; and

FIG. 8 illustrates a block diagram of an example computer readable medium in accordance with example implementations of the present disclosure.

Throughout the drawings, the same or similar reference numerals represent the same or similar element, unless otherwise provided.

### DETAILED DESCRIPTION

Principles of the present disclosure will now be described with reference to some example implementations. It is to be understood that these implementations are described only for the purpose of illustration and to help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as, but not limited to, fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT), Wi-Fi and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned systems.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

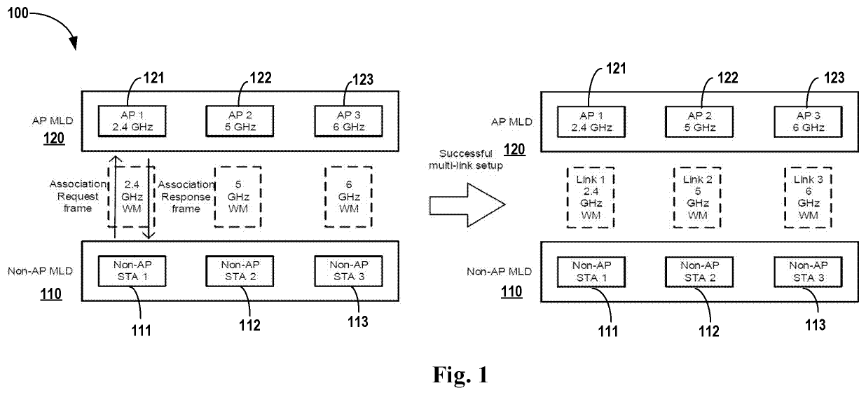

FIG. 1 illustrates an example communication environment 100 in which embodiments of the present disclosure can be implemented. As shown in FIG. 1, the communication environment 100 comprises a non-AP MLD 110 and an AP MLD 120. It will be understood that an MLD is a logical entity. An MLD acting as an AP may be referred to as an AP MLD, and an MLD acting as a non-AP may be referred to as a non-AP MLD.

The non-AP MLD 110 has affiliated non-AP STAs 111, 112 and 113. Hereinafter, a non-AP STA is also referred to as STA for brevity. The AP MLD 120 has affiliated APs 121, 122 and 123. The AP 121 operates on 2.4 GHz band, the AP 122 operates on 5 GHz band, and the AP 123 operates on 6 GHz band.

It is to be understood that the number of the non-AP STAs affiliated with the non-AP MLD 110 and the number of the APs affiliated with the AP MLD 120 as shown in FIG. 1 are only for the purpose of illustration without suggesting any limitations. The communication environment 100 may include any suitable number of STAs affiliated with the non-AP MLD 110 and any suitable number of APs affiliated with the AP MLD 120 adapted for implementing embodiments of the present disclosure.

The non-AP MLD 110 may perform an MLO to discover, authenticate, associate, and set up multiple links with the AP MLD 120.

During a discovery phase, the non-AP MLD 110 may transmit an (ML) probe request to scan the AP MLD 120 through one of the STAs 111, 112 and 113 affiliated with the non-AP MLD 110. Herein the term (ML) probe request is to be understood to mean a multi-link probe request or a single-link probe request. The same definition applies to (ML) probe response. For example, the STA 111 may transmit a (ML) probe request to scan the AP MLD 120. Typically, an MAC address of the STA 111 may be carried in the probe request instead of an MLD MAC address of the non-AP MLD 110. What is more, a service set identifier (SSID) of the AP MLD 120 may be present in the probe request when the STA 111 performs active channel scanning.

For AP MLD discovery, the STA 111 may send an ML probe request to discover an AP wherein a Probe Request variant Multi-Link element and an extremely high throughput (EHT) capabilities element may be further present in the ML probe request. The ML probe request allows the STA 111 to request one of the APs 121, 122 and 123 to include the complete or partial set of capabilities, parameters and operation elements of other APs affiliated with the AP MLD 120. In response to the probe request the STA 111, the AP MLD 120 may send an (ML) probe response to the STA 111. Besides the SSID of the AP MLD 120, additional information including the Basic variant Multi-Link element, the EHT Capabilities element or/and the EHT Operation element will be present in the probe response.

In the case where the SSID of the AP MLD 120 carried in the (ML) probe response is the same as the SSID stored at the STA 111, the STA 111 may connect to the AP MLD 120 with the SSID of the AP MLD 120 and password (PWD) pair information stored at the STA 111 after authentication.

After authentication, each link enables channel access and frame exchanges between the non-AP MLD 110 and the AP MLD 120 based on the supported capabilities exchanged during association. When the non-AP MLD 110 intends to perform multi-link (re)setup with the AP MLD 120, the non-AP MLD 110 and the AP MLD 120 may exchange (Re)Association Request/Response frames. The Association Request/Response frame exchange is for a multi-link setup if both the frames carried Basic Multi-Link element. Otherwise, the (Re)Association Request/Response frame exchange is not for a multi-link setup. An example of multi-link setup will be described with reference to FIG. 1. Herein the term (re)association should be understood to encompass both an association and a return to association after a disassociation, as the case may be.

As shown in FIG. 1, the non-AP MLD 110 initiates a multi-link setup procedure and the non-AP STA 111 affiliated with the non-AP MLD 110 sends an Association Request frame to AP 121 affiliated with the AP MLD 120. That is, a transmitter address (TA) field of the Association Request frame is set to the MAC address of the non-AP STA 111 and an receiver address (RA) field of the Association Request frame is set to an MAC address of the AP 121. The Association Request frame may comprise complete information of the affiliated STAs 111, 112 and 113 to request three links to be setup. That is, a link 1 is to be setup between the AP 121 and the non-AP STA 111, a link 2 is to be setup between the AP 122 and the non-AP STA 2, and a link 3 is to be setup between the AP 123 and the non-AP STA 113.

In addition, the Association Request frame may also comprise a Basic variant Multi-Link element that indicates the MLD MAC address of the non-AP MLD 110. The AP MLD 120 then responds to the requested multi-link setup, and the AP 121 affiliated with the AP MLD 120 sends an Association Response frame to the non-AP STA 111 affiliated with the non-AP MLD 110 to indicate successful multi-link setup. For example, the TA field of the Association Response frame may be set to the MAC address of the AP 121 and the RA field of the Association Response frame may be set to the MAC address of the non-AP STA 111.

Furthermore, the Association Response frame may comprise complete information of the AP 121, the AP 122, and the AP 123 and a Basic variant Multi-Link element that indicates the MLD MAC address of the AP MLD 120. After successful multi-link setup between the non-AP MLD 110 and the AP MLD 120, three links are setup. That is, the link 1 is setup between the AP 121 and the non-AP STA 111, the link 2 is setup between the AP 122 and the non-AP STA 2, and the link 3 is setup between the AP 123 and the non-AP STA 113.

In some implementations, a communication device may provide a distributed system (DS). In other words, the DS may run on the wireless device. The DS may create an AP with a public SSID for which the access permission is limited. Thus, all legacy STAs and non-AP MLDs may discover and access the AP. Hereinafter, an AP with a public SSID is also referred to as a public AP. Similarly, an AP MLD with a public SSID is also referred to as a public AP MLD

In addition, to deliver a high-quality user experience for some non-AP MLD and legacy STA, the DS may also create an AP MLD with a private unique SSID. Hereinafter, an AP MLD with a private SSID is also referred to as a private AP MLD. In this case, a non-AP MLD may access the private AP MLD using the private SSID and PWD pair information which is allocated by the DS.

If multi-link connection is set up between the non-AP MLD and the private AP MLD, the DS will acquire an MLD MAC address of the non-AP MLD as well as MAC addresses of the non-AP STAs affiliated with the non-AP MLD based on (re)association frame exchange. For example, the DS may acquire the MLD MAC address of the non-AP MLD as well as the MAC addresses of the non-AP STAs affiliated with the non-AP MLD using the (re)association frame exchange procedure as described with reference to FIG. 1.

When the non-AP MLD disconnects with the private AP MLD (for example, when the non-AP MLD is out of home) and later needs to access the private AP MLD again (for example, when the non-AP MLD is back inside the home), the non-AP MLD will send an (ML) probe request frame to scan the channel through one STA affiliated with the non-AP MLD. Typically, the STA affiliated with the non-AP MLD shall have been associated with the private AP MLD and the MAC address of the STA is stored at the DS. The private AP MLD will identify the non-AP MLD through the MAC address of the STA and thus allow the non-AP MLD to automatically connect to the private AP MLD. For this, the private AP MLD will transmit an (ML) probe response to the STA with the private SSID of the private AP MLD. Upon receiving the (ML) probe response, the STA may access the private AP MLD with the SSID and PWD pair information provided by the DS. In this case, the private AP MLD shall be able to identify the non-AP MLD through the MAC address of the STA in the discovery phase, which would benefit home automation including arrival detection as an example. A key feature of the home automation system is to allow it to recognize when one of residents arrives and “welcoming” them home by turning on lights, music, and the like which is tailored to an individual.

However, taking a buffer size of a non-AP MLD list stored at the DS into account, depending on implementation of the DS, the DS may only store the MLD MAC address of the non-AP MLD rather than MAC addresses of STAs affiliated with the non-AP MLD. What is more, if the STA affiliated with the non-AP MLD has never been associated with the private AP MLD, the MAC address of the STA will not be stored at the DS. If so, the DS will not be able to identify the STA through the MAC address of the STA, and thus will not send a probe response to the STA in response to an (ML) probe request from the STA. Consequently, the non-AP MLD will not be able to discover the private AP MLD, which would cause a waste of resources and latency as additional procedure would be required to set up links with the private AP MLD.

Furthermore, after the non-AP MLD disconnects with the private AP MLD, the DS will typically destroy the private AP MLD to recycle the resource. In this case, the private AP MLD will not be able to monitor the (ML) probe request from the non-AP MLD, and thus the non-AP MLD is not able to discover the private AP MLD.

Therefore, the DS may not be able to identify the non-AP MLD in the discovery phase and thus would not create a private AP MLD for it due to, for example, at least one of the following: the MAC address of the STA affiliated with the non-AP MLD unavailable, the resource recycle, or release of the private AP MLD.

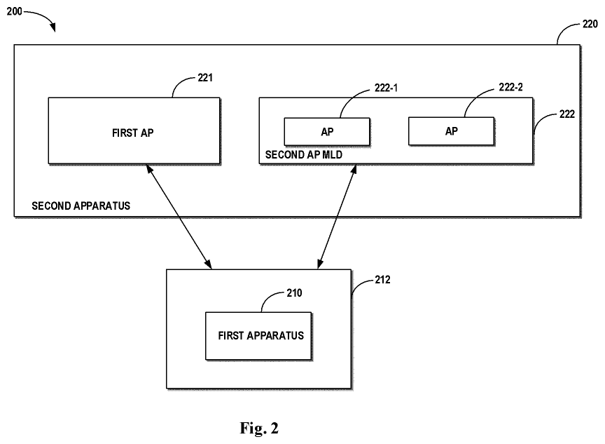

Example embodiments of the present disclosure provide a solution for identification and discovery of a device so as to solve the above problems and one or more of other potential problems. According to the solution, an apparatus transmits an MLD MAC address of the non-AP MLD to a first AP. If the first AP determines that the MLD MAC address of the non-AP MLD is associated with a private SSID of a second AP MLD, the first AP creates the second AP MLD for the non-AP MLD. Then, the second AP MLD transmits the private SSID to the apparatus for a connection between the first apparatus and the second AP MLD. In this way, the non-AP MLD may be identified during the discovery phase which benefits automatic connection with the AP network or AP MLD network. In addition, this solution may facilitate resource recycle and release after the non-AP MLD disconnects with the AP MLD. Hereinafter, principles of the present disclosure will be described with reference to FIGS. 2 to 8.

FIG. 2 illustrates another example communication environment 200 in which embodiments of the present disclosure can be implemented. As shown in FIG. 2, the communication environment 200 comprises a first apparatus 210 and a second apparatus 220.

The first apparatus 210 may be implemented as a communication device. In some implementations, the first apparatus 210 may be implemented as a non-AP STA affiliated with a non-AP MLD 212. For example, the non-AP MLD 212 may be implemented as the non-AP MLD 110 and the first apparatus 210 may be implemented as one of the non-AP STAs 111, 112 and 113 as shown in FIG. 1.

The second apparatus 220 may be implemented as a communication device. The second apparatus 220 comprises a first AP 221 and a second AP MLD 222. In some implementations, the first AP 221 may be implemented as a single-link AP device. Alternatively, the first AP 221 may be implemented as an AP affiliated with an AP MLD. For example, the first AP 221 may be implemented as the AP 121 affiliated with the AP MLD 120 as shown in FIG. 1. In such implementations, similar to the AP MLD 120, the first AP 221 may have a plurality of APs affiliated with the first AP 221.

In some embodiments, the second AP MLD 222 may have a plurality of APs affiliated with the second AP MLD 222. For example, the second AP MLD 222 may APs 222-1 and 222-2 affiliated with the second AP MLD 222. In some embodiments, each of the APs 222-1 and 222-2 may operate in a similar way to any of the APs 121, 122 and 124 in FIG. 1.

Merely for the purpose of illustration and without suggesting any limitations as to the scope of the present disclosure, some embodiments will be described in the context where the first apparatus 210 is implemented as a non-AP STA and the first AP 221 in the second apparatus 220 is implemented as an AP MLD. Thus, the first apparatus 110 may be also referred to as a non-AP STA 210.

It is to be understood that in other embodiments, the first apparatus 110 may be implemented as other communication device than the non-AP STA and the first AP 221 in the second apparatus 120 may be implemented as a single-link AP device.

The communications in the communication environment 200 may conform to any suitable standards for wireless local area network or a cellular network, including, but not limited to, Wi-Fi, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, Wi-Fi 7, the first generation (1G), the second generation (2G), 2.5G, 2.75G, the third generation (3G), the fourth generation (4G), 4.5G, the fifth generation (5G), 5G-advanced, and the sixth generation (6G) communication protocols.

The first apparatus 210 transmits an MLD MAC address of the non-AP MLD 212 to the first AP 221. If the first AP 221 determines that the MLD MAC address of the non-AP MLD 212 is associated with a private SSID of the second AP MLD 222, the first AP 221 creates the second AP MLD 222 for the non-AP MLD 212. Then, the second AP MLD 222 transmits the private SSID to the first apparatus 210 for a connection between the first apparatus 210 and the second AP MLD 222. In some embodiments, the second AP MLD 222 may direct its affiliated AP to transmit the private SSID to the first apparatus 210. For example, the second AP MLD 222 may direct the affiliated AP 222-1 to transmit the private SSID to the first apparatus 210. In this way, the non-AP MLD 212 may be identified during the discovery phase which benefits automatic connection with the AP (MLD) network. In addition, this solution may facilitate resource recycle and release after the non-AP MLD disconnects with the AP MLD.

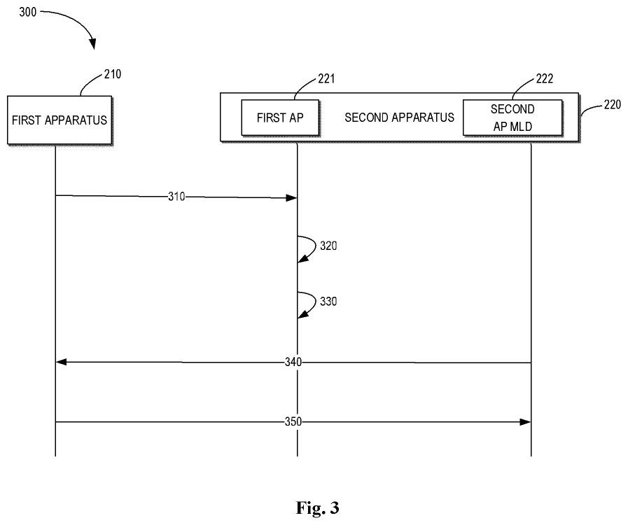

FIG. 3 illustrates a signaling chart illustrating a process 300 for identification and discovery of a device in accordance with some example embodiments of the present disclosure. The process 300 may involve the first apparatus 210 and the second apparatus 220 as illustrated in FIG. 2. Although the process 300 will be described in the communication environment 200 of FIG. 2, this process may be likewise applied to other communication scenarios.

In the process 300, it is assumed that the DS in the second apparatus 220 may create the first AP MLD 221 with a public SSID. In this case, the legacy STA and non-AP MLD may discover and access that the first AP MLD 221 with certain access permission managed by the DS. In order to provide a high-quality experience for the non-AP MLD 212, the DS would create the second AP MLD 222 with a private unique SSID for the non-AP MLD 212. After the non-AP MLD 212 breaks the connection with the second AP MLD 222 and needs to connect to the second AP MLD 222 with the private SSID and PWD pair information stored at the non-AP MLD 212 again, the non-AP MLD 212 may initiate the process 300 so that the DS can discover the non-AP MLD 212 and thus create the second AP MLD 222 for the non-AP MLD 212.

As shown in FIG. 3, the first apparatus 210 transmits 310, to the first AP 221 in the second apparatus 220, an MLD MAC address of the non-AP MLD 212 with which the first apparatus 210 is affiliated. Accordingly, the first AP 221 receives the MLD MAC address of the non-AP MLD 212.

In some embodiments, to connect to the second AP MLD 222, the non-AP MLD 212 may direct the first apparatus 210 affiliated with the non-AP MLD 212 to perform channel scanning by transmitting an ML probe request. In some embodiments, the first apparatus 210 may transmit the ML probe request where the MLD MAC address of the non-AP MLD 212 is present in the Probe Request variant Multi-Link element.

In such implementations, the first AP 221 may assist the DS to monitor the ML probe request from the first apparatus 210 affiliated with the non-AP MLD 212 to obtain the MLD MAC address of the non-AP MLD 212.

Upon obtaining the MLD MAC address of the non-AP MLD 212, the DS determines 320 whether the MLD MAC address of the non-AP MLD 212 is associated with a private SSID of the second AP MLD 222.

In some embodiments, the DS may maintain a list which comprises mapping between MLD MAC addresses of non-AP MLDs and private SSIDs of associated AP MLDs. The DS may search the list for the MLD MAC address of the non-AP MLD 212 or the private SSID of the second AP MLD 222. If the MLD MAC address of the non-AP MLD 212 or the private SSID of the second AP MLD 222 is found in the list, the DS may determine that the MLD MAC address of the non-AP MLD 212 is associated with the private SSID of the second AP MLD 222.

In turn, the DS creates 330 the second AP MLD 222 with the private SSID for the non-AP MLD 212.

In some embodiments, the DS may create the second AP MLD 222 based on context information of the second AP MLD 222 which is stored locally. In some embodiments, the context information of the second AP MLD 222 may include per-link profile and security information of associated non-AP MLD.

Upon creating the second AP MLD 222, the second AP MLD 222 transmits 340 the private SSID of the second AP MLD 222 to the first apparatus 210 for establishment of a connection between the first apparatus 210 and the second AP MLD 222.

In embodiments where the first apparatus 210 transmits the ML probe request comprising the MLD MAC address of the non-AP MLD 212, the second AP MLD 222 may transmit, to the first apparatus 210, an ML probe response comprising the private SSID of the second AP MLD 222.

Upon receiving the private SSID of the second AP MLD 222 from the second AP MLD 222, the first apparatus 210 establishes 350 a connection between the first apparatus 210 and the second AP MLD 222 using at least the private SSID.

In some embodiments, the DS may allocate the PWD associated with the private SSID of the second AP MLD 222 for the first apparatus 210 in advance. In this case, the first apparatus 210 may store the PWD locally. Thus, the first apparatus 210 may establish the connection between the first apparatus 210 and the second AP MLD 222 using the private SSID and PWD pair information stored at local.

With the process 300, the non-AP MLD is identified through a frame during the discovery phase which benefits automatic connection with the private AP MLD, even if the STA affiliated with the non-AP MLD has not ever been associated with the private AP MLD or MAC address of the STA is not buffered or stored at the private AP MLD.

In addition, the process 300 may facilitate resource recycle or release after the non-AP MLD disconnects with the private AP MLD. For example, the private AP MLD may recycle or release the resource by flushing the STA information or releasing the private AP MLD.

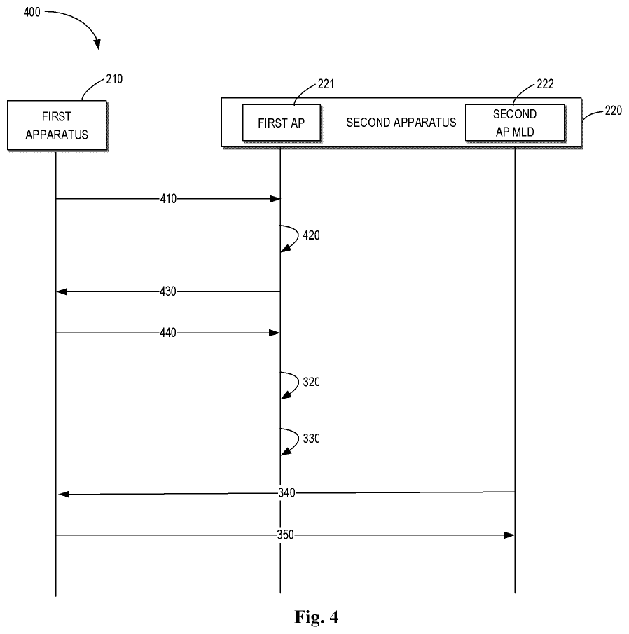

In some embodiments, the first apparatus 210 may receive, from the first AP 221, a request for the MLD MAC address of the non-AP MLD 212. Then, the first apparatus 210 may transmit to the first AP 221 a response to the request. The response comprises the MLD MAC address of the non-AP MLD 212. This will be described with reference to FIG. 4.

FIG. 4 illustrates a signaling chart illustrating a process 400 for identification and discovery of a device in accordance with other example embodiments of the present disclosure. The process 400 may involve the first apparatus 210 and the second apparatus 220 as illustrated in FIG. 2. The process 400 may be considered as an example implementation of the process 300. Although the process 400 will be described in the communication environment 200 of FIG. 2, this process may be likewise applied to other communication scenarios. It will be understood that the same assumptions described with reference to FIG. 3 are applied to the process 400.

As shown in FIG. 4, to connect to the second AP MLD 222, the non-AP MLD 212 may direct the first apparatus 210 affiliated with the non-AP MLD 212 to perform channel scanning by transmitting 410 a probe request.

In some embodiments, the first apparatus 210 may transmit a probe request with a broadcast destination address. In this case, the private SSID of the second AP MLD 222 stored at the first apparatus 210 will not be carried in the probe request.

In other embodiments, the first apparatus 210 may transmit a probe request frame where the private SSID of the second AP MLD 222 stored at the first apparatus 210 will be carried in the probe request.

The first AP 221 monitors 420 the probe request from the first apparatus 210 affiliated with the non-AP MLD 212.

In some embodiments, the DS may direct the first AP MLD 221 to transmit 430, to the first apparatus 210, a request for the MLD MAC address of the non-AP MLD 212.

In some embodiments, the probe request may comprise capability information of the first apparatus 210, an SSID and an MAC address of the first apparatus 210. In such embodiments, the first AP MLD 221 may transmit the request for the MLD MAC address of the non-AP MLD 212 in response to at least one of the following:
determining, based on the capability information of the first apparatus 210, that the first apparatus 210 is affiliated with the non-AP MLD 212,
the SSID in the probe request being associated with the second AP MLD 222, or
the MAC address of the first apparatus 210 being not stored at the second apparatus 220.

In some embodiments, the first AP MLD 221 may optionally transmit a probe response to the first apparatus 210. For example, if the RA in the probe request is a broadcast address, the first AP MLD 221 may transmit a probe response to the first apparatus 210.

In some embodiments, the first AP MLD 221 may transmit, to the first apparatus 210, a first frame comprising the request for the MLD MAC address of the non-AP MLD 212. For example, the first frame may be a new defined action frame.

Upon receiving the request for the MLD MAC address of the non-AP MLD 212 from the first AP 221, the first apparatus 210 may transmit 440 to the first AP 221 a response to the request. The response comprises the MLD MAC address of the non-AP MLD 212.

In some embodiments, the first apparatus 210 may transmit, to the first AP 221, a second frame comprising the MLD MAC address of the non-AP MLD. For example, the second frame may be a new defined action frame.

The actions 320, 330, 340 and 350 in the process 400 are identical to those in process 300. Thus, the details of these actions are omitted for brevity.

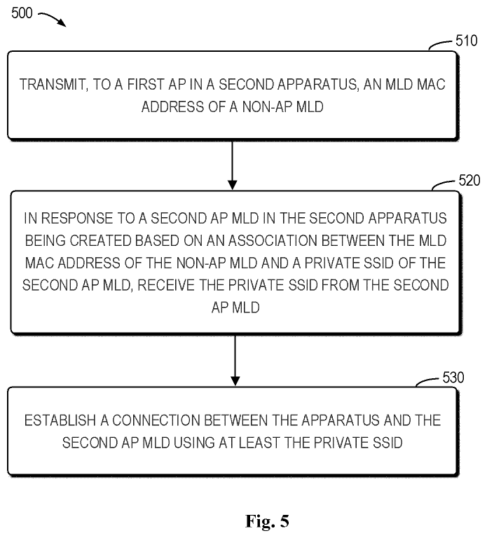

FIG. 5 shows a flowchart of an example method 500 implemented at a first apparatus in accordance with some example embodiments of the present disclosure. For the purpose of discussion, the method 500 will be described from the perspective of the first apparatus 210 with reference to FIG. 2.

At block 510, the first apparatus 210 transmits, to a first AP in a second apparatus, an MLD MAC address of a non-AP MLD.

At block 520, in response to a second AP MLD in the second apparatus being created based on an association between the MLD MAC address of the non-AP MLD and a private SSID of the second AP MLD, the first apparatus 210 receives the private SSID from the second AP MLD.

At block 530, the first apparatus 210 establishes a connection between the apparatus and the second AP MLD using at least the private SSID.

In some embodiments, transmitting the MLD MAC address of the non-AP MLD comprises: in response to receiving, from the first AP, a request for the MLD MAC address of the non-AP MLD, transmitting to the first AP a response to the request, the response comprising the MLD MAC address of the non-AP MLD.

In some embodiments, receiving the request for the MLD MAC address of the non-AP MLD comprises: receiving a first frame comprising the request.

In some embodiments, transmitting the MLD MAC address of the non-AP MLD comprises: transmitting a second frame comprising the MLD MAC address of the non-AP MLD.

In some embodiments, transmitting the MLD MAC address of the non-AP MLD comprises: transmitting a Multi-Link probe request to the first AP, the Multi-Link probe request comprising a Probe Request variant Multi-Link element, the element comprising the MLD MAC address of the non-AP MLD.

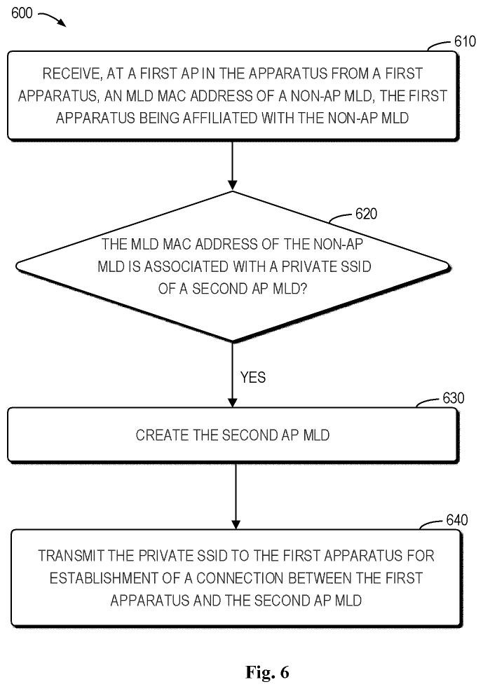

FIG. 6 shows a flowchart of an example method 600 implemented at a second apparatus in accordance with some example embodiments of the present disclosure. For the purpose of discussion, the method 600 will be described from the perspective of the second apparatus 220 with reference to FIG. 2.

At block 610, the second apparatus 220 receives, at a first AP in the second apparatus 220, from a first apparatus, an MLD MAC address of a non-AP MLD. The first apparatus is affiliated with the non-AP MLD.

At block 620, the second apparatus 220 determines whether the MLD MAC address of the non-AP MLD is associated with a private SSID of a second AP MLD.

If the MLD MAC address of the non-AP MLD is associated with the private SSID of the second AP MLD, the second apparatus 220 creates, at block 630, the second AP MLD.

At block 640, the second apparatus 220 transmits the private SSID to the first apparatus for establishment of a connection between the first apparatus and the second AP MLD.

In some embodiments, the method 600 further comprises: transmitting, to the first apparatus, a request for the MLD MAC address of the non-AP MLD. In such embodiments, receiving the MLD MAC address of the non-AP MLD comprises: receiving a response to the request from the first apparatus, the response comprising the MLD MAC address of the non-AP MLD.

In some embodiments, transmitting the request for the MLD MAC address of the non-AP MLD comprises: transmitting a first frame comprising the request.

In some embodiments, the method 600 further comprises: receiving a probe request from the first apparatus, the probe request comprising capability information of the first apparatus, an SSID and an MAC address of the first apparatus. In such embodiments, transmitting the request for the MLD MAC address of the non-AP MLD comprises: transmitting the request in response to at least one of the following: determining, based on the capability information of the first apparatus, that the first apparatus is affiliated with the non-AP MLD, the SSID in the probe request being associated with the second AP MLD, or the MAC address of the first apparatus being not stored at the second apparatus.

In some embodiments, receiving the response to the request comprises: receiving a second frame comprising the MLD MAC address of the non-AP MLD.

In some embodiments, receiving the MLD MAC address of the non-AP MLD comprises: receiving a Multi-Link probe request from the first apparatus, the Multi-Link probe request comprising a Probe Request variant Multi-Link element, the element comprising the MLD MAC address of the non-AP MLD.

In some embodiments, creating the second AP MLD comprises: creating the second AP MLD based on context information of the second AP MLD which is stored locally.

The example embodiments of the present disclosure which have been described with reference to FIGS. 1 to 4 may be also applied to the methods 500 and 600. Thus, the details of the example embodiments are omitted.

In some example embodiments, an apparatus capable of performing any of the method 500 (for example, a first apparatus) may comprise means for performing the respective steps of the method 500. The means may be implemented in any suitable form. For example, the means may be implemented in a circuitry or software module or a combination thereof.

In some example embodiments, an apparatus comprises a first device. The first device has: means for transmitting, to a first AP in a second device, an MLD MAC address of a non-AP MLD, the apparatus being affiliated with the non-AP MLD; in response to a second AP MLD in the second device being created based on an association between the MLD MAC address of the non-AP MLD and a private SSID of the second AP MLD, means for receiving the private SSID from the second AP MLD; and means for establishing a connection between the apparatus and the second AP MLD using at least the private SSID.

In some embodiments, means for transmitting the MLD MAC address of the non-AP MLD comprises: in response to receiving, from the first AP, a request for the MLD MAC address of the non-AP MLD, means for transmitting to the first AP a response to the request, the response comprising the MLD MAC address of the non-AP MLD.

In some embodiments, means for receiving the request for the MLD MAC address of the non-AP MLD comprises: means for receiving a first frame comprising the request.

In some embodiments, means for transmitting the MLD MAC address of the non-AP MLD comprises: means for transmitting a second frame comprising the MLD MAC address of the non-AP MLD.

In some embodiments, means for transmitting the MLD MAC address of the non-AP MLD comprises: means for transmitting a Multi-Link probe request to the first AP, the Multi-Link probe request comprising a Probe Request variant Multi-Link element, the element comprising the MLD MAC address of the non-AP MLD.

In some example embodiments, an apparatus capable of performing any of the method 600 (for example, a second apparatus) may comprise means for performing the respective steps of the method 600. The means may be implemented in any suitable form. For example, the means may be implemented in a circuitry or software module or a combination thereof.

In some example embodiments, an apparatus comprises a second device. The second device has: means for receiving, at a first AP in the second device from a first device, an MLD MAC address of a non-AP MLD, the first device being affiliated with the non-AP MLD; means for creating the second AP MLD in accordance with a determination that the MLD MAC address of the non-AP MLD is associated with a private SSID of a second AP MLD in the second device; and means for transmitting the private SSID to the first device for establishment of a connection between the first device and the second AP MLD.

In some embodiments, the apparatus further comprises: means for transmitting, to the first apparatus, a request for the MLD MAC address of the non-AP MLD. In such embodiments, means for receiving the MLD MAC address of the non-AP MLD comprises: means for receiving a response to the request from the first apparatus, the response comprising the MLD MAC address of the non-AP MLD.

In some embodiments, means for transmitting the request for the MLD MAC address of the non-AP MLD comprises: means for transmitting a first frame comprising the request.

In some embodiments, the apparatus further comprises: means for receiving a probe request from the first apparatus, the probe request comprising capability information of the first apparatus, an SSID and an MAC address of the first apparatus. In such embodiments, means for transmitting the request for the MLD MAC address of the non-AP MLD comprises: means for transmitting the request in response to at least one of the following: determining, based on the capability information of the first apparatus, that the first apparatus is affiliated with the non-AP MLD, the SSID in the probe request being associated with the second AP MLD, or the MAC address of the first apparatus being not stored at the second apparatus.

In some embodiments, means for receiving the response to the request comprises: means for receiving a second frame comprising the MLD MAC address of the non-AP MLD.

In some embodiments, means for receiving the MLD MAC address of the non-AP MLD comprises: means for receiving a Multi-Link probe request from the first apparatus, the Multi-Link probe request comprising a Probe Request variant Multi-Link element, the element comprising the MLD MAC address of the non-AP MLD.

In some embodiments, means for creating the second AP MLD comprises: means for creating the second AP MLD based on context information of the second AP MLD which is stored locally.

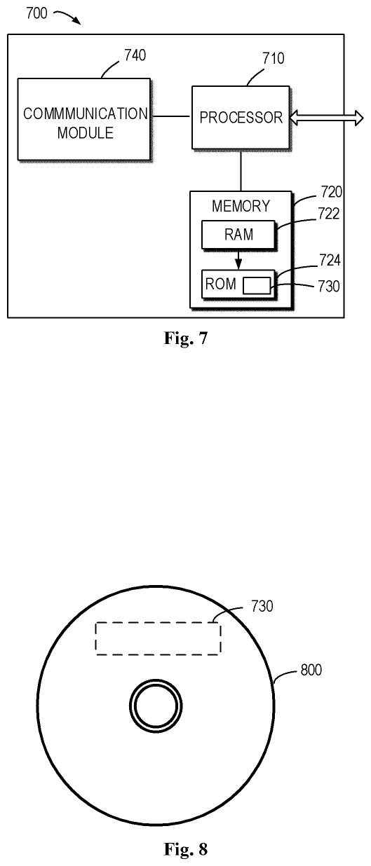

FIG. 7 is a simplified block diagram of a device 700 that is suitable for implementing embodiments of the present disclosure. The device 700 may be provided to implement the communication device, for example, the first apparatus 110 or the second device 120 as shown in FIG. 1, or the first apparatus 210 or the second device 220 as shown in FIG. 2. As shown, the device 700 includes one or more processors 710, one or more memories 720 coupled to the processor 710, and one or more communication modules 740 coupled to the processor 710.

The communication module 740 is configured for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the memory 720, e.g. ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 1 to 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, for the device to carry out the methods 500 and 600 as described above with reference to FIGS. 5 and 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

### LIST OF ACRONYMS AND ABBREVIATIONS

AP access point
Non-AP MLD non-access-point multi-link device
DS: distributed system
LCC: logical link control
MAC: medium access control
ML: multi-link
MLD: multi-link device
MLO: multi-link operation
PWD: password
QOS: quality of service
RCPI: received channel power indicator
RSSI: reference signal strength
SAP: service access point
SINR: signal to interference plus noise ratio
SSID: service set identifier
STA: station

1-28. (canceled)

29. An apparatus, comprising:
at least one processor; and
at least one memory storing instructions that, when executed by the at least one processor, cause the apparatus at least to:
affiliate with a non-access-point multi-link device, non-AP MLD;
transmit, to a first access-point, AP, in a second apparatus, a multi-link device medium access control, MLD MAC, address of the non-AP MLD;
in response to a second access-point multi-link device, AP MLD, in the second apparatus being created based on an association between the MLD MAC address of the non-AP MLD and a private service set identifier, SSID, of the second AP MLD, receive the private SSID from the second AP MLD; and
establish a connection between the apparatus and the second AP MLD using at least the private SSID.

30. The apparatus of claim 29, configured to:
in response to receiving, from the first AP, a request for the MLD MAC address of the non-AP MLD, transmit to the first AP a response to the request, the response comprising the MLD MAC address of the non-AP MLD.

31. The apparatus of claim 30, configured to receive the request for the MLD MAC address of the non-AP MLD by:
receiving a first frame comprising the request.

32. The apparatus of claim 30, configured to transmit
a second frame comprising the MLD MAC address of the non-AP MLD.

33. The apparatus of claim 29, configured to transmit a multi-link probe request to the first AP, the multi-link probe request comprising a probe request variant multi-link element, the element comprising the MLD MAC address of the non-AP MLD.

34. An apparatus comprising:
at least one processor; and
at least one memory storing instructions that, when executed by the at least one processor, cause the apparatus at least to:
receive, at a first access-point, AP, in the apparatus from a first apparatus, a multi-link device medium access control, MLD MAC, address of a non-access-point multi-link device, non-AP MLD, the first apparatus being affiliated with the non-AP MLD;
in accordance with a determination that the MLD MAC address of the non-AP MLD is associated with a private service set identifier, SSID, of a second AP MLD in the apparatus, create the second AP MLD; and
transmit the private SSID to the first apparatus for establishment of a connection between the first apparatus and the second AP MLD.

35. The apparatus of claim 34, configured to transmit, to the first apparatus, a request for the MLD MAC address of the non-AP MLD; and
receive a response to the request from the first apparatus, the response comprising the MLD MAC address of the non-AP MLD.

36. The apparatus of claim 35, configured to:
receive a probe request from the first apparatus, the probe request comprising capability information of the first apparatus, an SSID and an MAC address of the first apparatus; and
transmit the request for the MLD MAC address of the non-AP MLD in response to at least one of the following:
determining, based on the capability information of the first apparatus, that the first apparatus is affiliated with the non-AP MLD,
the SSID in the probe request being associated with the second AP MLD, or
the MAC address of the first apparatus being not stored at the second apparatus.

37. The apparatus of claim 35, configured to receive the response to the request by:
receiving a second frame comprising the MLD MAC address of the non-AP MLD.

38. The apparatus of claim 34, configured to receive the MLD MAC address of the non-AP MLD by:
receiving a multi-link probe request from the first apparatus, the multi-link probe request comprising a probe request variant multi-link element, the element comprising the MLD MAC address of the non-AP MLD.

39. The apparatus of claim 34, configured to create the second AP MLD based on context information of the second AP MLD which is stored locally.

40. A method, comprising:
transmitting, from an apparatus to a first access-point, AP, in a second apparatus, a multi-link device medium access control, MLD MAC, address of a non-access-point multi-link Device, non-AP MLD, the apparatus being affiliated with the non-AP MLD;
in response to a second access-point multi-link device, AP MLD, in the second apparatus being created based on an association between the MLD MAC address of the non-AP MLD and a private service set identifier, SSID, of the second AP MLD, receiving the private SSID from the second AP MLD; and
establishing a connection between the apparatus and the second AP MLD using at least the private SSID.

41. The method of claim 40, wherein transmitting the MLD MAC address of the non-AP MLD comprises:
in response to receiving, from the first AP, a request for the MLD MAC address of the non-AP MLD, transmitting to the first AP a response to the request, the response comprising the MLD MAC address of the non-AP MLD.

42. The method of claim 40, wherein transmitting the MLD MAC address of the non-AP MLD comprises:
transmitting a multi-link probe request to the first AP, the multi-link probe request comprising a probe request variant multi-link element, the element comprising the MLD MAC address of the non-AP MLD.

43. The method of claim 41, wherein transmitting the MLD MAC address of the non-AP MLD comprises:
transmitting a second frame comprising the MLD MAC address of the non-AP MLD.

44. A method, comprising:
receiving, at a first access-point, AP, in an apparatus, from a first apparatus, a multi-link device medium access control, MLD MAC, address of a non-access-point multi-link device, non-AP MLD, the first apparatus being affiliated with the non-AP MLD;
in accordance with a determination that the MLD MAC address of the non-AP MLD is associated with a private service set identifier, SSID, of a second access-point multi-link device, AP MLD, creating the second AP MLD; and
transmitting the private SSID to the first apparatus for establishment of a connection between the first apparatus and the second AP MLD.

45. The method of claim 44, further comprising:
transmitting, to the first apparatus, a request for the MLD MAC address of the non-AP MLD; and
wherein receiving the MLD MAC address of the non-AP MLD comprises:
receiving a response to the request from the first apparatus, the response comprising the MLD MAC address of the non-AP MLD.

46. The method of claim 44, wherein receiving the MLD MAC address of the non-AP MLD comprises:
receiving a multi-link probe request from the first apparatus, the multi-link probe request comprising a probe request variant multi-link element, the element comprising the MLD MAC address of the non-AP MLD.

47. A computer readable medium comprising program instructions for causing an apparatus to perform the method according to claim 40.

48. A computer readable medium comprising program instructions for causing an apparatus to perform the method according to claim 43.
